(19) United States
(12) Patent Application Publication
(10) Pub. No.: US 2005/0057782 A1
(43) Pub. Date: Mar. 17, 2005

(54) Mail recognizing and processing system and method

(76) Inventors: Thomas Sheng, Hsinchu (TW); Bo-Hsiang Wang, Taiping City (TW)

Correspondence Address: BIRCH STEWART KOLASCH & BIRCH, PO BOX 747, FALLS CHURCH, VA, 22040-0747, US

(21) Appl. No.: 10/929,487

(22) Filed: Aug. 31, 2004

(30) Foreign Application Priority Data
Sep. 17, 2003 (TW) 092125640

(51) Int. Cl. H04M 11/00

(52) U.S. Cl. 358/402

(57) ABSTRACT

A mail recognizing and processing system includes a document scanner and a mail processing machine. The document scanner includes a scanning module, a processor, and a network interface. The scanning module is for scanning a document set and obtaining to-be-delivered mail information, which includes receiptor data and mail content data. The processor is for processing the mail information into a first digital signal. The first digital signal includes the separated receiptor data and mail content data and is outputted from the network interface. The mail processing machine receives the first digital signal of the document scanner via a network and produces a deliverable mail package according to the receiptor data and the mail content data of the first digital signal.

### BACKGROUND OF THE INVENTION

1. Field of the Invention

The invention relates to mail recognizing and processing system and method, and a document scanner and a mail processing machine using the same, and more particularly to a mail recognizing and processing system composed of an application specific document scanner and a mail processing machine in conjunction with a network, and a method therefor.

2. Description of the Related Art

Although advertisement letters can be conveniently sent via E-mail or FAX, the conventional post mail still plays an important role because it is simple, convenient and clear, as well as it can be sent to the users having no information products such as computers.

In a company having to send a lot of advertisement letters, it is possible to pack and then send the advertisement letters manually, or to use a mail processing machine instead of the human work.

On the other hand, in a company having to send a lot of invoices, it is preferred to use the conventional post mail because some originals are needed.

In the conventional mail processing machine, after the letters and envelopes are printed, an automatic document folding device is typically used to fold the letters, and then an automatic packing device is used to pack the letter into the envelope, on which the receiptor information has been printed. When the mail processing machine is used, the user usually has to use the word processing software and typesetting software to process and then transfer the data of the electric files to the mail processing machine. Thus, the user cannot use the mail processing machine to process the handwritten letter into the deliverable state.

On the other hand, when the user wants to deliver the mail, which is processed by the mail processing machine, to a foreign country or other zones, he or she has to spend a lot of money. In addition, as the deliver distance gets longer, the deliver time gets longer. So, the mail delivering is inefficient in time-saving.

At present, before the user delivers the mail, he or she usually has to write the mail content data, put the mail content data into the envelope, write the receiptor data (e.g., receiptor's name and address) on the envelope, and then pack the envelope. Alternatively, the envelope may have a transparent region, and the user may write the receiptor data at the location of the letter corresponding to the transparent region, and write the mail content data on other portions of the letter or another letter. The receiptor data may be seen through the transparent region, and the mail can be successfully delivered.

Thus, the ways for processing the receiptor data and the mail content data are different. When the receiptor data and the mail content data are located on the same document set, which may include a single sheet or multiple sheets, it is inconvenient because the receiptor data and the mail content data still have to be separated and individually processed manually even the automatic mail processing machine is used.

### SUMMARY OF THE INVENTION

It is therefore an object of the invention to provide a mail recognizing and processing system and a method therefor, which are capable of saving the mail cost, shortening the mailing time, and separating the receiptor data from the mail content data.

To achieve the above-mentioned object, the invention provides a mail recognizing and processing system including a document scanner and a mail processing machine. The document scanner includes a scanning module, a processor and a network interface. The scanning module scans a document set and obtains to-be-delivered mail information. The mail information includes receiptor data and mail content data. The processor processes the mail information into a first digital signal. The first digital signal includes the separated receiptor data and the mail content data and is outputted from the network interface. The mail processing machine receives the first digital signal of the document scanner via a network, and produces a deliverable mail package according to the receiptor data and the mail content data of the first digital signal.

Using the above-mentioned mail recognizing and processing system may simplify the mail producing procedure.

### BRIEF DESCRIPTION OF THE DRAWINGS

FIG. 1 is a schematic illustration showing various stages of a mail recognizing and processing method of the invention.

FIG. 2 is a block diagram showing a mail recognizing and processing system according to a first embodiment of the invention.

FIG. 3 is a block diagram showing a mail recognizing and processing system according to a second embodiment of the invention.

### DETAILED DESCRIPTION OF THE INVENTION

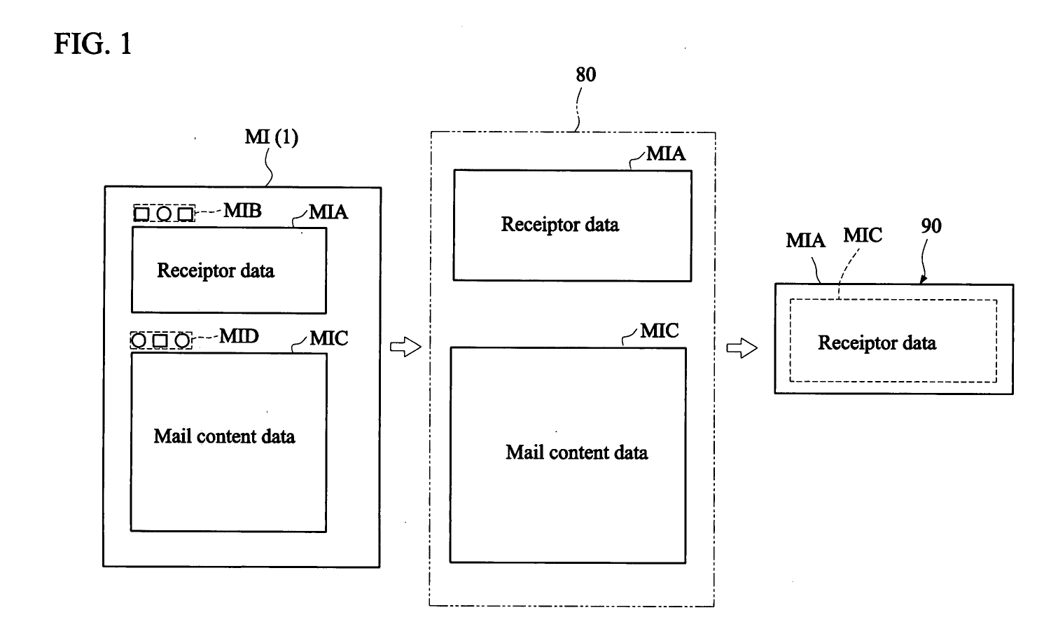

FIG. 1 is a schematic illustration showing various stages of a mail recognizing and processing method of the invention. As shown in FIG. 1, the object of the invention is to transfer mail information MI on a document set 1 to a mail processing machine via a network after a document scanner has scanned and recognized the mail information MI. The mail processing machine may print a mail document set 80 according to the recognized data, and then produce the mail document set 80 into a deliverable mail package 90.

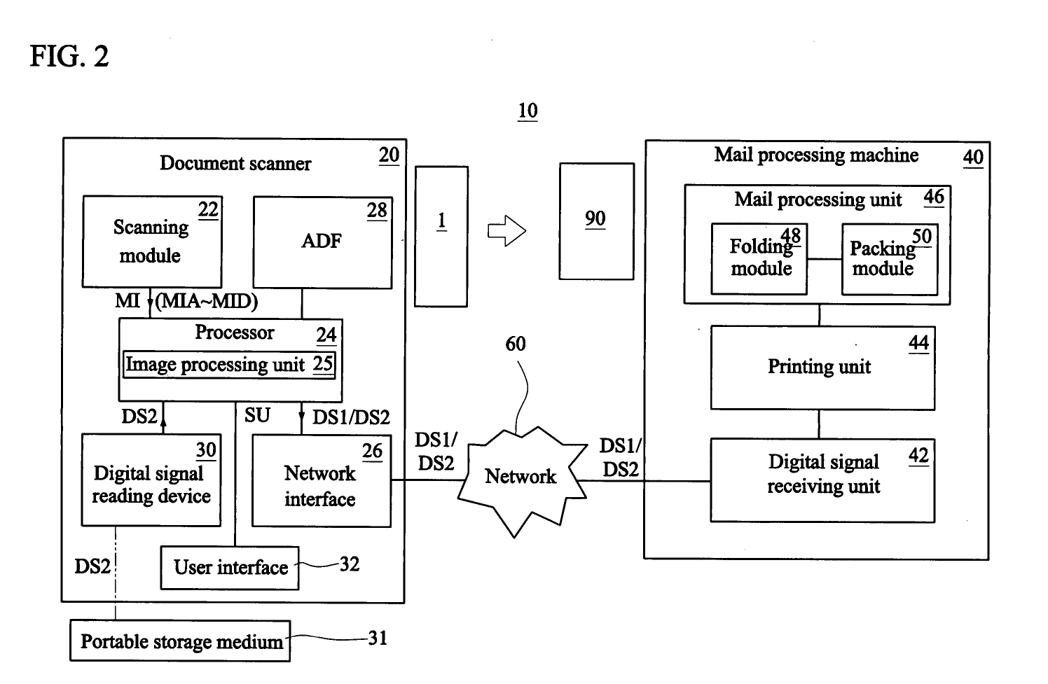

FIG. 2 is a block diagram showing a mail recognizing and processing system according to a first embodiment of the invention. Referring to FIG. 2, the mail recognizing and processing system 10 of this embodiment includes a document scanner 20 and a mail processing machine 40. The document scanner 20 includes a scanning module 22, a processor 24, a network interface 26, an automatic document feeder (ADF) 28, a digital signal reading device 30 and a user interface 32.

The scanning module 22 is for scanning a document set 1 and obtaining to-be-delivered mail information MI, which may be stored as an image file. Usually, the document set 1 may be a single-page or a multi-page document set, and also may be a reflective or transmittive type document. The mail information MI includes receiptor data MIA and mail content data MIC, and may also include receiptor mark MIB and mail content mark MID. The data and marks are mixed in the document set 1, as shown in FIG. 1. The receiptor mark MIB and the mail content mark MID may be any mark, such as texts, bar codes, color codes, or images, for respectively marking the positions of the receiptor data MIA and the mail content data MIC.

The processor 24 processes the mail information MI into a first digital signal DS1 that may be transferred via a network 60. Also, the processor 24 may be configured such that it can control the operation of the document scanner 20. The processor 24 has an image processing unit 25 for separating the receiptor data MIA from the mail content data MIC according to the receiptor mark MIB and the mail content mark MID. Thus, the image processing unit 25 needs to have the image recognizing and processing function, and the first digital signal DS1 includes the separated receiptor data MIA and mail content data MIC.

The network interface 26 is for outputting the first digital signal DS1. The automatic document feeder 28 is an optional member and is for automatically feeding the document set for the scanning module 22 to scan. It is more convenient when the document set has multiple pages of documents.

The digital signal reading device 30 is an optional member and is for reading a second digital signal DS2 of a portable storage medium 31 and transferring the second digital signal DS2 to the processor 24. For example, the digital signal reading device 30 may be a card reader, a floppy disk drive, an optical disk drive, or a connection port, such as a USB connection port, which may access the data of a portable hard disk.

The processor 24 outputs the second digital signal DS2 through the network interface 26, and the mail processing machine 40 can further receive the second digital signal DS2 coming from the document scanner 20 via the network 60, and produce another deliverable mail package 90 according to the second digital signal DS2. The user interface 32 is also an optional member, which may be a keyboard or mouse. A user may control the digital signal reading device 30 to read the second digital signal DS2 or the first digital signal DS1. Furthermore, the user interface 32 is also provided such that the user can preview and select the mail content data MIC. In this case, the processor 24 separates the receiptor data MIA from the mail content data MIC according to a selection signal SU of the user. For example, the user interface 32 may also include a display and a keyboard or mouse. Thus, the user can preview the mail information MI on the display of the document scanner 20, and then crop the receiptor data MIA and the mail content data MIC on the displayed image to generate the selection signal SU. Alternatively, the user interface 32 itself may be a set of computer including a display and a mouse or a keyboard. In this case, it is allowable that the mail information MI does not include the receiptor mark MIB and the mail content mark MID.

Thus, when the user needs to deliver the prepared document, he or she may scan the prepared mail (document set) using the document scanner 20, wherein the document set may include the receiptor data MIA and the mail content data MIC, or even the sender data. The mail information MI is transferred to the processor 24, which processes the mail information MI into the first digital signal DS1. Then, the first digital signal DS1 is outputted via the network interface 26 and the network 60. The network 60 may be the Intranet or Ethernet.

Then, the mail processing machine 40 can receive the first digital signal DS1 coming from the document scanner 20 via the network 60, and produce the deliverable mail package 90 according to the receiptor data MIA and the mail content data MIC of the first digital signal DS1. The so-called deliverable mail package 90 includes, without limitation to, a package placed into the envelope and a folded package of a single document. If the package placed into the envelope is to be produced, it is preferred that the receiptor data MIA and the mail content data MIC are printed separately. The condition of the folded package of the single document may be applied to the typical advertisement letter, wherein the receiptor data MIA and the mail content data MIC are printed on the same sheet, and the receiptor data is located at a specific location after the sheet is folded and then stapled by a stapler or adhered by a tape or an adhesive.

The mail processing machine 40 includes a digital signal receiving unit 42, a printing unit 44 and a mail processing unit 46. The digital signal receiving unit 42 receives the first digital signal DS1 via the network 60, the printing unit 44 prints the mail document set 80 according to the first digital signal DS1, and the mail processing unit 46 processes the mail document set 80 into the deliverable mail package 90. The mail processing unit 46 includes a folding module 48 for folding the mail document set 80, and a packing module 50 for packing the mail document set 80. It is to be noted that the operations of the packing module 50 can include, without limitation to, the operation for placing and packing the letter into the envelope, as well as the operation for packing the folded mail document set 80 coming from the folding module 48. Furthermore, the packing module 50 may be omitted. In this case, the folding module 48 may directly fold and pack the mail document set into the mail package 90.

The invention also provides a mail processing method, which is used in the mail recognizing and processing system, and includes the following steps. First, the scanning module 22 of the document scanner 20 is used to scan the document set and obtain the to-be-delivered mail information MI, which includes the receiptor data MIA and the mail content data MIC. Then, the processor 24 of the document scanner 20 is used to process the mail information MI into the first digital signal DS1, and to separate the receiptor data MIA from the mail content data MIC. Next, the network interface 26 of the document scanner 20 is used to output the first digital signal DS1 via the network 60.

Then, the digital signal receiving unit 42 of the mail processing machine 40 is used to receive the first digital signal DS1 via the network 60. Thereafter, the printing unit 44 and the mail processing unit 46 are used to produce the deliverable mail package 90 according to the receiptor data MIA and the mail content data MIC of the first digital signal DS1. For example, it is possible to utilize the printing unit 44 to print the mail document set 80 according to the first digital signal DS1, and utilize the mail processing unit 46 to process the mail document set 80 into the deliverable mail package 90. This can be achieved by using the folding module 48 to fold the mail document set 80, and the packing module 50 to pack the mail document set 80.

In the above-mentioned method, the receiptor data MIA and the mail content data MIC may be automatically separated according to the marks MIB and MID, or manually separated according to the user's selection operation, as mentioned above. Alternatively, the system may be configured such that the user may have two choices.

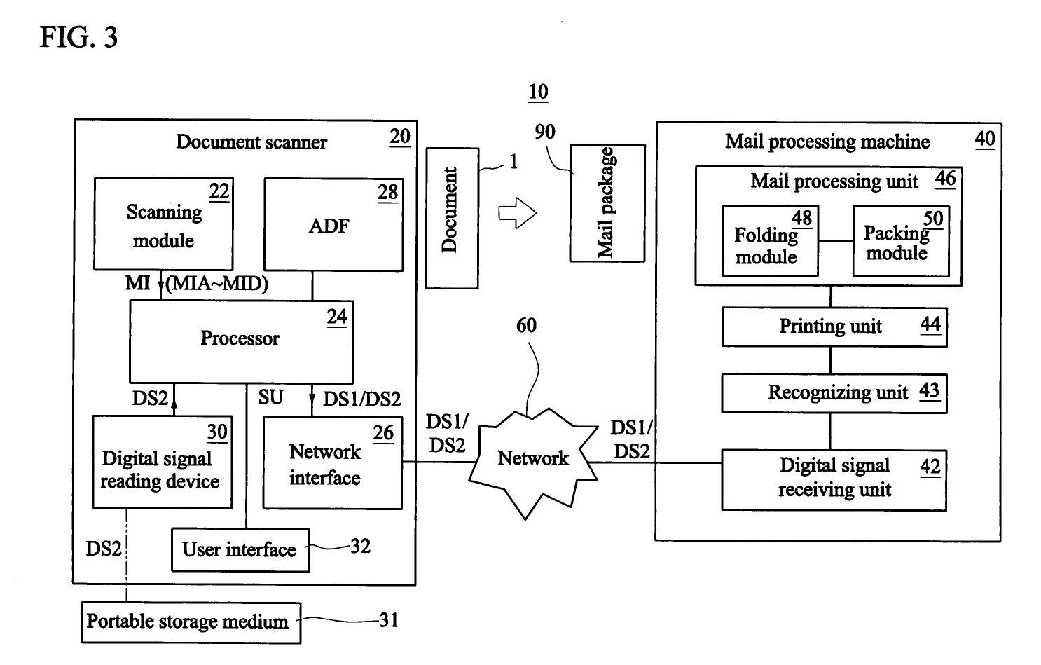

FIG. 3 is a block diagram showing a mail recognizing and processing system according to a second embodiment of the invention. As shown in FIG. 3, the embodiment is similar to the first embodiment but different from the first embodiment in that the operation for separating the receiptor data MIA from the mail content data MIC is performed in the mail processing machine 40 but not the document scanner 20. Thus, the mail processing machine 40 includes a digital signal receiving unit 42, a recognizing unit 43, a printing unit 44 and a mail processing unit 46. In addition, the image processing unit 25 in the processor 24 of the document scanner 20 may be omitted.

The digital signal receiving unit 42 receives a first digital signal DS1 coming from the document scanner 20 via a network 60. The first digital signal DS1 includes the mixed receiptor data MIA, receiptor mark MIB, mail content data MIC and mail content mark MID. The recognizing unit 43 recognizes the receiptor data MIA and the mail content data MIC and separates the receiptor data MIA from the mail content data MIC according to the receiptor mark MIB and the mail content mark MID. The printing unit 44 prints a mail document set 80 according to the receiptor data MIA and the mail content data MIC of the first digital signal DS1. The mail processing unit 46 processes the mail document set 80 into a deliverable mail package 90. Similarly, the mail processing unit 46 may include a folding module 48 for folding the mail document set 80, and a packing module 50 for packing the mail document set 80.

Hence, a mail recognizing and processing method of the second embodiment includes the following steps. First, the document set 1 is scanned and the to-be-delivered mail information MI, which includes the receiptor data MIA, the receiptor mark MIB, the mail content data MIC and the mail content mark MID, is obtained. Next, the mail information MI is processed into the first digital signal DS1. At this time, the receiptor data MIA and the mail content data MIC of the first digital signal DS1 are not separated yet. Then, the first digital signal DS1 is outputted. Thereafter, the first digital signal DS1 coming from the document scanner 20 is received via the network 60, and an image recognizing process is executed in order to separate the receiptor data MIA from the mail content data MIC according to the receiptor mark MIB and the mail content mark MID. Finally, the deliverable mail package 90 is produced according to the receiptor data MIA and the mail content data MIC of the first digital signal DS1.

Using the above-mentioned mail recognizing and processing system may effectively shorten the mail delivering time, reduce the delivering cost, and separate the receiptor data from the mail content data so as to simplify the user's operation. Examples will be illustrated in the following.

### EXAMPLE 1

In this example, it is assumed that the document scanner 20 is set at the head office in Taiwan and the mail processing machine 40 is set at the affiliate in U.S.A. The user may transfer the mail from the head office in Taiwan to the affiliate in U.S.A. according to the mail recognizing and processing system, and then the mail may be delivered via the domestic post mail from the affiliate in U.S.A. Thus, the delivering cost of the air mail or express mail may be eliminated, and the delivering time from Taiwan to U.S.A. may be greatly shortened.

The user also can conveniently use the mail recognizing and processing system of the invention to produce the deliverable mail package from a handwritten letter, on which the marks MIB and MID are marked. In this example, the letter sheet may have the format and mark specified by the head office or affiliate.

### EXAMPLE 2

In this example, it is assumed that various mail processing machines 40 are set at various post offices. The user may purchase the document scanner 20 and use the document scanner 20 to scan the to-be-delivered document. Then, the mail document 80 may be transferred to the mail processing machine 40 in some post office, which may be a foreign one or a domestic one, via the network 60. Thus, the user can deliver the mail without going to the post office, and a lot of time and mailing cost may be saved.

Also, the user can conveniently use the mail recognizing and processing system of the invention to produce the deliverable mail package from a handwritten letter, on which the marks MIB and MID are marked. In this example, the letter sheet may have the format and mark specified by the post office.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A mail recognizing and processing system, comprising:
a document scanner, which comprises:
a scanning module for scanning a document set and obtaining to-be-delivered mail information, which comprises receiptor data and mail content data;
a processor for processing the mail information into a first digital signal for output, wherein the first digital signal comprises the receiptor data and the mail content data that are separated; and
a network interface for outputting the first digital signal; and
a mail processing machine for receiving the first digital signal of the document scanner via a network and producing a deliverable mail package according to the receiptor data and the mail content data of the first digital signal.

2. The system according to claim 1, wherein the mail information further comprises a receiptor mark and a mail content mark, and the processor executes an image recognizing process so as to separate the receiptor data from the mail content data according to the receiptor mark and the mail content mark.

3. The system according to claim 2, wherein the document scanner further comprises:
a user interface, on which a user can preview and select the mail content data, wherein the processor can further separate the receiptor data from the mail content data according to a selection signal inputted by the user.

4. The system according to claim 1, wherein the document scanner further comprises:
a user interface, on which a user can preview and select the mail content data, wherein the processor separates the receiptor data from the mail content data according to a selection signal inputted by the user.

5. The system according to claim 4, wherein the user interface is a computer.

6. The system according to claim 1, wherein the document scanner further comprises:
an automatic document feeder for automatically feeding the document set for the scanning module to scan.

7. The system according to claim 1, wherein the document scanner further comprises:
a digital signal reading device for reading a second digital signal of a portable storage medium and transmitting the second digital signal to the processor so that the processor outputs the second digital signal via the network interface, and the mail processing machine can further receive the second digital signal of the document scanner via the network, and produce another deliverable mail package according to the second digital signal; and
a user interface, through which a user can control the digital signal reading device to read the second digital signal.

8. The system according to claim 1, wherein the mail processing machine comprises:
a digital signal receiving unit for receiving the first digital signal via the network;
a printing unit for printing a mail document set according to the first digital signal; and
a mail processing unit for processing the mail document set into the deliverable mail package.

9. The system according to claim 8, wherein the mail processing unit comprises:
a folding module for folding and packing the mail document set into the deliverable mail package.

10. The system according to claim 8, wherein the mail processing unit comprises:
a folding module for folding the mail document set; and
a packing module for packing the mail document set.

11. A document scanner being used in a mail recognizing and processing system, the document scanner comprising:
a scanning module for scanning a document set and obtaining to-be-delivered mail information, which comprises receiptor data and mail content data;
a processor for processing the mail information into a first digital signal for output, wherein the first digital signal comprises the receiptor data and the mail content data that are separated; and
a network interface for outputting the first digital signal.

12. The document scanner according to claim 11, wherein the mail information further comprises a receiptor mark and a mail content mark, and the processor executes an image recognizing process so as to separate the receiptor data from the mail content data according to the receiptor mark and the mail content mark.

13. The document scanner according to claim 12, further comprising:
a user interface, on which a user can preview and select the mail content data, wherein the processor can further separate the receiptor data from the mail content data according to a selection signal inputted by the user.

14. The document scanner according to claim 11, further comprising:
a user interface, on which a user can preview and select the mail content data, wherein the processor separates the receiptor data from the mail content data according to a selection signal inputted by the user.

15. The document scanner according to claim 14, wherein the user interface is a computer.

16. The document scanner according to claim 11, further comprising:
an automatic document feeder for automatically feeding the document set for the scanning module to scan.

17. The document scanner according to claim 11, further comprising:
a digital signal reading device for reading a second digital signal of a portable storage medium and transmitting the second digital signal to the processor so that the processor outputs the second digital signal via the network interface; and
a user interface, through which a user can control the digital signal reading device to read the second digital signal.

18. A mail processing machine being used in a mail recognizing and processing system, the mail processing machine comprising:
a digital signal receiving unit for receiving a first digital signal of a document scanner via a network, wherein the first digital signal comprises a receiptor data, a receiptor mark, a mail content data and a mail content mark, all of which are mixed;
a recognizing unit for recognizing the receiptor data and the mail content data and separating the receiptor data from the mail content data according to the receiptor mark and the mail content mark;
a printing unit for printing a mail document set according to the receiptor data and the mail content data of the first digital signal; and
a mail processing unit for processing the mail document set into a deliverable mail package.

19. The mail processing machine according to claim 18, wherein the mail processing unit comprises:
a folding module for folding and packing the mail document set into the deliverable mail package.

20. The mail processing machine according to claim 18, wherein the mail processing unit comprises:
a folding module for folding the mail document set; and
a packing module for packing the mail document set.

21. A mail recognizing and processing method, comprising the steps of:
scanning a document set to obtain to-be-delivered mail information, which comprises receiptor data and mail content data;
processing the mail information into a first digital signal and separating the receiptor data from the mail content data for output;
outputting the first digital signal; and
receiving the first digital signal of a document scanner via a network, and producing a deliverable mail package according to the receiptor data and the mail content data of the first digital signal.

22. The method according to claim 21, wherein the mail information further comprises a receiptor mark and a mail content mark, and the receiptor data and the mail content data are separated according to the receiptor mark and the mail content mark by way of image recognizing.

23. The method according to claim 22, further comprising the steps of:
displaying the mail content data for preview on a user interface for a user; and
separating the receiptor data from the mail content data according to a selection signal inputted by the user on the user interface.

24. The method according to claim 21, further comprising the steps of:
displaying the mail content data for preview on a user interface for a user; and
separating the receiptor data from the mail content data according to a selection signal inputted by the user on the user interface.

25. A mail recognizing and processing method, comprising the steps of:
scanning a document set to obtain to-be-delivered mail information, which comprises receiptor data, a receiptor mark, mail content data and a mail content mark;
processing the mail information into a first digital signal for output;
outputting the first digital signal;
receiving the first digital signal of a document scanner via a network;
executing an image recognizing process so as to separate the receiptor data from the mail content data according to the receiptor mark and the mail content mark; and
producing a deliverable mail package according to the receiptor data and the mail content data of the first digital signal.
